(19) United States
(12) Patent Application Publication
(10) Pub. No.: US 2020/0184499 A1
(43) Pub. Date: Jun. 11, 2020

(54) VEHICLE-TO-VEHICLE CHARGING SERVICE PROVIDING METHOD

(71) Applicants: HYUNDAI MOTOR COMPANY, Seoul (KR); KIA MOTORS CORPORATION, Seoul (KR)

(72) Inventor: Young Rang Lee, Gimpo-si (KR)

(21) Appl. No.: 16/298,688

(22) Filed: Mar. 11, 2019

(30) Foreign Application Priority Data
Dec. 6, 2018 (KR) 10-2018-0156388

(51) Int. Cl. G06Q 30/02; G06Q 10/02; B60L 53/10; B60L 53/35; G06F 16/9035

(52) U.S. Cl. CPC G06Q 30/0206; G06Q 10/02; G06F 16/9035; B60L 53/35; B60L 53/10

(57) ABSTRACT

A vehicle-to-vehicle charging service providing method includes: transmitting, by a supplier who wants to charge another electric vehicle, supplier information, which is charging related information that can be provided, to a server via a supplier terminal; inputting, by a demander who wants to charge an electric vehicle, demander information via a demander terminal; selecting suppliers corresponding to the demander information from supplier information of the server; acquiring supplier information of the filtered suppliers from the server and providing the acquired supplier information to the demander via the demander terminal in a selectable manner; transmitting supplier information selected by the demander from the supplier information provided to the demander to the server via the demander terminal; and transmitting, by the server, completion information indicating completion of charging reservation matching to a supplier selected by the demander and to the demander.

### CROSS REFERENCE TO RELATED APPLICATION

The present application claims priority to Korean Patent Application No. 10-2018-0156388, filed De. 6, 2018, the entire contents of which is incorporated herein for all purposes by this reference.

### BACKGROUND

### Field

The present disclosure relates generally to a vehicle charging service providing method.

### Description of the Related Art

At present, one of the major obstacles to expansion of use of electric vehicles is lack of charging stations and a long charging time.

In recent years, vehicle manufacturers have been providing a service, called “on-site charging service” to provide an on-site charging service to demanders who want to charge vehicles, which is helpful for electric vehicle users.

The foregoing is intended merely to aid in the understanding of the background of the present invention, and is not intended to mean that the present invention falls within the purview of the related art that is already known to those skilled in the art.

### SUMMARY

One aspect of the present invention provides a vehicle-to-vehicle charging service providing method, which mediates between a demander who wants to charge an electric vehicle and a supplier who has a vehicle capable of charging another electric vehicle, thereby alleviating shortage of charging stations of electric vehicles and reducing inconvenience of lack of charging services or service waiting time, while contributing to expansion of use of electric vehicles.

Another aspect of the invention provides a vehicle-to-vehicle charging service providing method, including: transmitting, by a supplier who wants to charge another electric vehicle, supplier information, which is charging related information that can be provided, to a server via a supplier terminal; inputting, by a demander who wants to charge an electric vehicle, demander information via a demander terminal; filtering suppliers corresponding to the demander information from supplier information of the server; acquiring supplier information of the filtered suppliers from the server and providing the acquired supplier information to the demander via the demander terminal in a selectable manner; transmitting supplier information selected by the demander from the supplier information provided to the demander to the server via the demander terminal; and transmitting, by the server, completion information indicating completion of charging reservation matching to a supplier selected by the demander and to the demander.

The supplier information transmitted to the server may include information of at least one of start and end times of available supply, an available charging capacity, a location of a supplier vehicle, and a supply price.

The demander information input by the demander may include information of at least one of a desired charging start time, a required charging capacity, a desired charging location, and a location of a demander vehicle.

In the selecting the suppliers corresponding to the demander information, a supplier who has the available charging capacity greater than the required charging capacity of the demander; has the start and end times of available supply within which the desired charging start time falls; and has transmitted supplier information in which a time, which ranges from an expected charging start time that is a later time between a time at which the demander vehicle is expected to be able to move to a charging location and a time at which the supplier vehicle is expected to be able to move to the charging location to a time that results from adding to the expected charging start time a charging preparation time and a time expected to be required to charge the required charging capacity, falls within the start and end times of available supply may be selected as a supplier corresponding to the demander information.

If the desired charging location input by the demander is the location of the supplier vehicle, only a supplier who is able to arrive on the basis of remaining electric energy of the demander vehicle is selected as the supplier corresponding to the demander information.

If the desired charging location input by the demander is the location of the supplier vehicle, when providing the supplier information of the filtered suppliers to the demander in a selectable manner, the supplier information may be provided to the demander in order of shortest to longest distance from a current location of the demander vehicle to a destination via the location of the supplier vehicle.

If the desired charging location input by the demander is the location of the supplier vehicle, when providing the supplier information of the filtered suppliers to the demander in a selectable manner, the supplier information may be provided to the demander in order of shortest to longest time from a current location of the demander vehicle to a destination via the location of the supplier vehicle.

If the desired charging location input by the demander is the location of the supplier vehicle, when providing the supplier information of the filtered suppliers to the demander in a selectable manner, the supplier information may be provided to the demander in order of smallest to largest required energy from a current location of the demander vehicle to a destination via the location of the supplier vehicle.

If the desired charging location input by the demander is the location of the supplier vehicle, the demander may select one of shortest distance, shortest time, and minimum energy options; and when the demander selects one of the options and when providing the supplier information of the filtered suppliers to the demander in a selectable manner, between a distance, time, and required energy from a current location of the demander vehicle to a destination via the location of the supplier vehicle, information corresponding to the option selected by the demander may be provided to the demander in order of shortest to longest or smallest to largest.

Still another aspect of the present invention provides a vehicle-to-vehicle charging service providing method, including: transmitting, by a demander who wants to charge an electric vehicle, demander information to a server via a demander terminal; inputting, by a supplier who wants to charge another electric vehicle, supplier information, which is charging related information that can be provided, via a supplier terminal; filtering demanders corresponding to the supplier information from demander information of the server; acquiring demander information of the filtered demanders from the server and providing the acquired demander information to the supplier via the supplier terminal in a selectable manner; transmitting demander information selected by the supplier from the demander information provided to the supplier to the server via the supplier terminal; and transmitting, by the server, completion information indicating completion of charging reservation matching to a demander selected by the supplier and to the supplier.

The demander information transmitted to the server may include information of at least one of a desired charging start time, a required charging capacity, a desired charging location, a location of a demander vehicle, a driving destination, and a demand price; and the supplier information input by the supplier may include information of at least one of start and end times of available supply, an available charging capacity, a location of a supplier vehicle, and an available supply distance.

In the selecting the demanders corresponding to the supplier information, a demander who has the required charging capacity smaller than the available charging capacity; has the desired charging start time falling within the start and end times of available supply; and has transmitted demander information in which a time, which ranges from an expected charging start time that is a later time between a time at which the demander vehicle is expected to be able to move to a charging location and a time at which the supplier vehicle is expected to be able to move to the charging location to a time that results from adding to the expected charging start time a charging preparation time and a time expected to be required to charge the required charging capacity, falls within the start and end times of available supply may be selected as a demander corresponding to the supplier information.

When providing the demander information of the filtered demanders to the supplier in a selectable manner, only demander information of which the desired charging location input by the demander falls within the available supply distance may be selected and provided.

The available supply distance of the supplier may be changeably set by the supplier, and the available supply distance set by the supplier may be limited to a distance the supplier vehicle is able to reach on the basis of remaining electric energy at present.

A further aspect of the present invention provides a vehicle-to-vehicle charging service providing system for performing the vehicle-to-vehicle charging service providing method as described above and including: the supplier terminal; the demander terminal; and the server.

Embodiments of the present invention can provide mediation between the demander who wants to charge an electric vehicle and the supplier who has a vehicle capable of charging another electric vehicle, thereby alleviating shortage of charging stations of electric vehicles and reducing inconvenience of lack of charging services or service waiting time, while contributing to expansion of use of electric vehicles.

### BRIEF DESCRIPTION OF THE DRAWINGS

The above and other aspects, features and other advantages of the present invention will be more clearly understood from the following detailed description when taken in conjunction with the accompanying drawings, in which:

FIG. 1 is a flowchart showing an embodiment of a vehicle-to-vehicle charging service providing method according to embodiments of the present invention;

FIG. 2 is a configuration view showing an embodiment of a vehicle-to-vehicle charging service providing system according to embodiments of the present invention; and

FIG. 3 is a flowchart showing another embodiment of the vehicle-to-vehicle charging service providing method according to embodiments of the present invention.

### DETAILED DESCRIPTION OF EMBODIMENTS

Hereinbelow, embodiments of the present invention will be described in detail with reference to the accompanying drawings. Throughout the drawings, the same reference numerals will refer to the same or like parts.

In on-site charging services provided by vehicle manufacturers, demands may exceed requests for supply. Thus, the user may be able to receive the service only after waiting a long time depending on the situation. One solution would be vehicle-to-vehicle charging technology where an electric vehicle can charge another one with a vehicle's own inverter without using any other equipment.

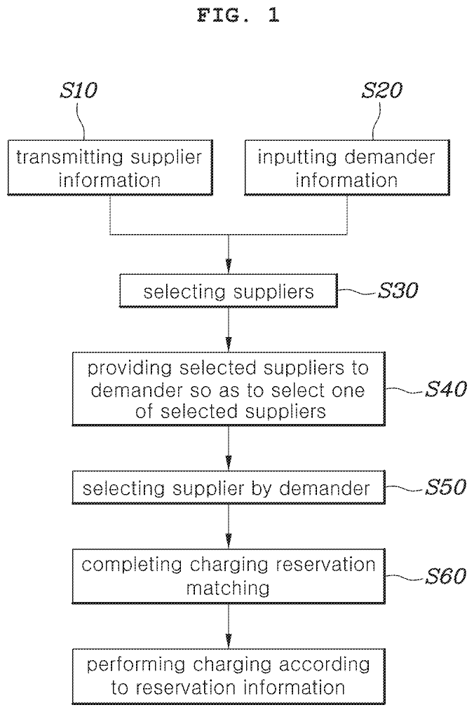

Referring to FIG. 1, an embodiment of a vehicle-to-vehicle charging service providing method according to embodiments of the present invention includes: transmitting, by a supplier who wants to charge another electric vehicle, supplier information, which is charging related information that can be provided, to a server via a supplier terminal (S10); inputting, by a demander who wants to charge an electric vehicle, demander information via a demander terminal (S20); filtering suppliers corresponding to the demander information from supplier information of the server (S30); acquiring supplier information of the filtered suppliers from the server and providing the acquired supplier information to the demander via the demander terminal in a selectable manner (S40); transmitting supplier information selected by the demander from the supplier information provided to the demander to the server via the demander terminal (S50); and transmitting, by the server, completion information indicating completion of charging reservation matching to a supplier selected by the demander and to the demander (S60).

In one embodiment, information on suppliers who want to charge another electric vehicle is collected by the server, and a list of suppliers corresponding to the demander information is provided such that the demander selects one of the suppliers for charging reservation matching.

Herein, the supplier may be an individual who has an electric vehicle, a company which has a charging vehicle, a charging station which has a charging vehicle or the like. In the present embodiment, the supplier terminal may be an audio video navigation (AVN) device, a supplier's smartphone, a supplier's personal computer (PC), or the like.

If the supplier terminal is a smartphone or a PC, in the process of transmitting the supplier information to the server, the smartphone or the PC communicates with a corresponding vehicle and automatically acquires, from the vehicle, vehicle state information from the supplier information to be transmitted to the server.

The supplier information transmitted to the server may include information of start and end times of available supply, an available charging capacity, a location of a supplier vehicle, and a supply price.

Of these, information of the available charging capacity and the location of the supplier vehicle is included in the vehicle state information as described above. This information may be configured such that information obtained from a battery management system (BMS), a global positioning system (GPS), and the like of the vehicle is directly transmitted to the server from the vehicle or may be configured to be collected at the supplier terminal and transmitted to the server along with other information such as the supply price and the like.

It is preferable that the demander terminal is the AVN device or the like mounted in an electric vehicle itself, but the demander terminal may also be a demander's smartphone or the like.

It is preferable that the demander information input by the demander includes information of a desired charging start time, a required charging capacity, a desired charging location, and a location of a demander vehicle.

If the demander's smartphone is used as the demander terminal as described above, the smartphone communicates with a corresponding vehicle to obtain information of the required charging capacity and the location of the demander vehicle.

It is preferable that the server performs filtration of the suppliers corresponding to the demander information from the supplier information of the server (S30).

In other words, the server receives the demander information, filters the suppliers corresponding to the demander information, and transmits the supplier information of the filtered suppliers to the demander terminal.

However, it is also possible for the server and the demander terminal to separately perform filtration of the suppliers. In other words, when at least a part of the demander information such as the location of the demander vehicle is transmitted from the demander terminal to the server, the server transmits supplier information corresponding thereto to the demander terminal on the basis of the received part of the information, and the demander terminal filters the supplier information corresponding to remaining demander information from the received supplier information.

In the filtering the suppliers corresponding to the demander information (S30), a supplier who: has the available charging capacity greater than the required charging capacity of the demander; has the start and end times of available supply within which the desired charging start time falls; and has transmitted supplier information in which a time, which ranges from an expected charging start time that is a later time between a time at which the demander vehicle is expected to be able to move to a charging location and a time at which the supplier vehicle is expected to be able to move to the charging location to a time that results from adding to the expected charging start time a charging preparation time and a time expected to be required to charge the required charging capacity, falls within the start and end times of available supply is filtered as a supplier corresponding to the demander information.

In one embodiment, the suppliers corresponding to the demander information have the available charging capacity greater than the demander's required charging capacity to provide charging to the demander, and the demander's desired charging start time fall within the start and end times of available supply.

The desired charging location input by the demander can be considered as the charging location, and there may be three cases regarding this. In one embodiment, it is a case where the desired charging location is the location of the demander vehicle, a case where the desired charging location is the location of the supplier vehicle, or a case where the desired charging location is a third location to which both the demander vehicle and the supplier vehicle move.

In embodiment, whichever of the above three cases the demander selects, the demander vehicle and the supplier vehicle meet in one place for charging. Accordingly, the expected charging start time is a time of a later-arriving vehicle when at least one of the demander vehicle and the supplier vehicle has moved to the desired charging location selected by the demander, and the time, which ranges from the time of the later-arriving vehicle to the time that results from by adding a general charging preparation time required for charging operations such as connecting cables and the like and the time required to charge the required charging capacity, fall within the start and end times of available supply provided by the supplier. If not, the supplier cannot be considered as the supplier corresponding to the demander information.

Herein, the charging preparation time uses a value such as 10 minutes determined by experiments and the like in consideration of a general situation. The time that is expected to be required to charge the required charging capacity is roughly estimated using average charging time data and a compensation value that takes into account effects of the atmospheric temperature, season, and the like.

In embodiments, if the desired charging location input by the demander is a location A, which is not the location of the demander vehicle or the location of the supplier vehicle, and if the demander vehicle is expected to arrive at 13:30 when moving to the location A, and if the supplier vehicle is expected to arrive at 13:40 when moving to the location A, the expected charging start time is 13:40. If the charging preparation time is 10 minutes and if the time expected to be required to charge the required charging capacity of the demander vehicle is 40 minutes, a charging end time is 14:30. Accordingly, in embodiments, if it is not determined that the start time of available supply of the supplier is at least 13:40 before and the end time of available supply thereof is after 14:30 minutes, the supplier cannot be selected as the supplier corresponding to the demander information.

On the other hand, if the desired charging location input by the demander is the location of the supplier vehicle, only a supplier who is able to arrive on the basis of remaining electric energy of the demander vehicle is selected as the supplier corresponding to the demander information.

Herein, the remaining electric energy is generally represented by information of state of charge (SOC) of a high voltage battery or distance to empty (DTE) of a cluster.

Furthermore, if the desired charging location input by the demander is the location of the supplier vehicle, when providing the supplier information of the filtered suppliers to the demander in a selectable manner, the supplier information is provided to the demander in order of shortest to longest distance from a current location of the demander vehicle to a destination via the location of the supplier vehicle.

Alternatively, in such a situation described above, the supplier information may be provided to the demander in order of shortest to longest time from the current location of the demander vehicle to the destination via the location of the supplier vehicle.

Alternatively, in such a situation described above, the supplier information may be provided to the demander in order of smallest to largest required energy from the current location of the demander vehicle to the destination via the location of the supplier vehicle.

In embodiments, if the desired charging location input by the demander is the location of the supplier vehicle, the demander can select one of shortest distance, shortest time, and minimum energy options. When the demander selects one of the options, and thereby when providing the supplier information of the filtered suppliers to the demander in a selectable manner, between a distance, time, and required energy from the current location of the demander vehicle to the destination via the location of the supplier vehicle, information corresponding to the option selected by the demander is provided to the demander in order of shortest to longest or smallest to largest.

Furthermore, when the demander selects desired supplier information from the supplier information presented in the above described order, the demander terminal transmits the selected information to the server, and the server transmits completion information indicating completion of charging reservation matching to the demander and the selected supplier, thus guiding the demander and the supplier to perform charging according to reservation information.

Herein, presenting or sending the supplier information of the filtered suppliers to the demander may be performed by a method of displaying through the AVN device. However, a method of using the latest voice recognition technology to present supplier information to the demander in the form of voice, thus allowing the demander to select one of the supplier information with voice is also possible.

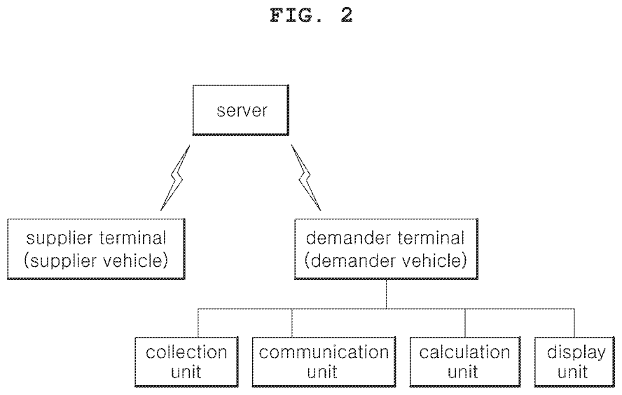

As shown in FIG. 2, a vehicle-to-vehicle charging service providing system for performing the vehicle-to-vehicle charging service providing method according to embodiments of the present invention as described above includes the supplier terminal, the demander terminal, and the server that are capable of performing the functions as described above.

The demander terminal includes a collection unit, a calculation unit, a communication unit, and a display unit.

In embodiments, the demander terminal includes the collection unit for inputting the demander information of the demander, the communication unit for communicating with the server, and the display unit for displaying various information such as the supplier information, and the AVN device of a similar type as described above is used.

For reference, although FIG. 2 shows that only the demander terminal includes the collection unit, the calculation unit, the communication unit, and the display unit, the supplier terminal also includes the same configuration.

The embodiment as described above allows the demander to select one of multiple suppliers, but conversely, for charging requests from multiple demanders, the supplier may be allowed to select one of these demanders who satisfies conditions. Accordingly, another embodiment of the present invention is an embodiment in which the supplier selects the demander.

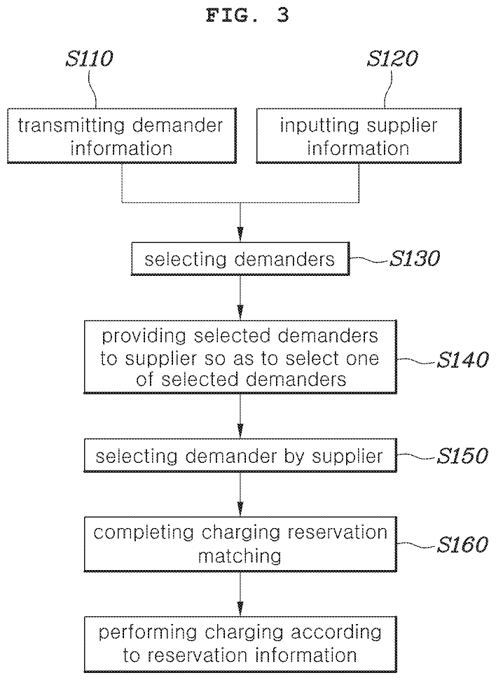

In embodiments, as shown in FIG. 3, another embodiment of the vehicle-to-vehicle charging service providing method according to embodiments of the present invention includes: transmitting, by a demander who wants to charge an electric vehicle, demander information to a server via a demander terminal (S110); inputting, by a supplier who wants to charge another electric vehicle, supplier information, which is charging related information that can be provided, via a supplier terminal (S120); filtering demanders corresponding to the supplier information from demander information of the server (S130); acquiring demander information of the filtered demanders from the server and providing the acquired demander information to the supplier via the supplier terminal in a selectable manner (S140); transmitting demander information selected by the supplier from the demander information provided to the supplier to the server via the supplier terminal (S150); and transmitting, by the server, completion information indicating completion of charging reservation matching to a demander selected by the supplier and to the supplier (S160).

The demander information transmitted to the server includes information of a desired charging start time, a required charging capacity, a desired charging location, a location of a demander vehicle, a driving destination, and a demand price. The supplier information input by the supplier includes information of start and end times of available supply, an available charging capacity, a location of a supplier vehicle, and an available supply distance.

Thus, the supplier checks the location of the demander vehicle, and the demand price, and the like to select a desired demander.

In the filtering the demanders corresponding to the supplier information (S130), a demander who: has the required charging capacity smaller than the available charging capacity; has the desired charging start time falling within the start and end times of available supply; and has transmitted demander information in which a time, which ranges from an expected charging start time that is a later time between a time at which the demander vehicle is expected to be able to move to a charging location and a time at which the supplier vehicle is expected to be able to move to the charging location to a time that results from adding to the expected charging start time a charging preparation time and a time expected to be required to charge the required charging capacity, falls within the start and end times of available supply is filtered as a demander corresponding to the supplier information.

In one embodiment, when the supplier selects the demander, the demander's required charging capacity must fall within the supplier's own available charging capacity, and the demander's desired charging start time must fall within the supplier's start and end times of available supply.

Furthermore, in one embodiment, the desired charging start time of the demander must fall between the expected charging start time and a time that results by adding the charging preparation time and an expected required charging time. If not, the demander cannot be selected as the demander corresponding to the supplier information.

Meanwhile, when providing the demander information of the filtered demanders to the supplier in a selective manner, only demander information of which the desired charging location input by the demander falls within the available supply distance is selected and provided.

Herein, it is preferable that the available supply distance of the supplier is changeably set by the supplier, and the available supply distance set by the supplier is limited to a distance the supplier vehicle is able to reach on the basis of remaining electric energy at present.

The supplier receives the demander information of the filtered demanders via the supplier terminal. Of these, information of a demander selected by the supplier is transmitted to the server, and the server transmits the supplier information to the selected demander to request approval of the demander. If there is an approval by the demander, the server transmits the completion information indicating the completion of charging reservation matching to both the demander and the supplier.

Furthermore, it is preferable that the embodiment of FIG. 1 and the embodiment of FIG. 3 are configured to be performed in parallel with each other such that a user can select a demander-centered method of FIG. 1 or a supplier-centered method of FIG. 3.

Logical blocks, modules or units described in connection with embodiments disclosed herein can be implemented or performed by a computing device having at least one processor, at least one memory and at least one communication interface. The elements of a method, process, or algorithm described in connection with embodiments disclosed herein can be embodied directly in hardware, in a software module executed by at least one processor, or in a combination of the two. Computer-executable instructions for implementing a method, process, or algorithm described in connection with embodiments disclosed herein can be stored in a non-transitory computer readable storage medium.

Although embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A vehicle-to-vehicle charging service providing method, comprising:
receiving, by a server from a supplier terminal of each of a plurality of suppliers who want to charge another electric vehicle, supplier information, which is charging related information that can be provided;
receiving, by the server from a demander terminal of a demander who wants to charge an electric vehicle, demander information;
filtering suppliers corresponding to the demander information based on supplier information of the server;
sending supplier information of the filtered suppliers to the demander terminal of the demander in a selectable manner;
receiving supplier information of one of the filtered suppliers selected by the demander from the demander terminal; and
transmitting, by the server, completion information indicating completion of charging reservation matching to the supplier terminal of the supplier selected by the demander and to the demander.

2. The vehicle-to-vehicle charging service providing method of claim 1, wherein the supplier information received by the server includes information of at least one of start and end times of available supply, an available charging capacity, a location of a supplier vehicle, and a supply price.

3. The vehicle-to-vehicle charging service providing method of claim 2, wherein the demander information received from the demander includes information of at least one of a desired charging start time, a required charging capacity, a desired charging location, and a location of a demander vehicle.

4. The vehicle-to-vehicle charging service providing method of claim 3, wherein the filtering the suppliers corresponding to the demander information comprises determining whether a supplier:
has the available charging capacity greater than the required charging capacity of the demander;
has the start and end times of available supply within which the desired charging start time falls; and
has transmitted supplier information in which a time, which ranges from an expected charging start time that is a later time between a time at which the demander vehicle is expected to be able to move to a charging location and a time at which the supplier vehicle is expected to be able to move to the charging location to a time that results from adding to the expected charging start time a charging preparation time and a time expected to be required to charge the required charging capacity, falls within the start and end times of available supply is filtered as a supplier corresponding to the demander information.

5. The vehicle-to-vehicle charging service providing method of claim 3, wherein if the desired charging location input by the demander is the location of the supplier vehicle, only a supplier who is able to arrive on the basis of remaining electric energy of the demander vehicle is filtered as the supplier corresponding to the demander information.

6. The vehicle-to-vehicle charging service providing method of claim 3, wherein if the desired charging location input by the demander is the location of the supplier vehicle,
when sending the supplier information of the filtered suppliers to the demander in a selectable manner, the supplier information is provided to the demander in order of shortest to longest distance from a current location of the demander vehicle to a destination via the location of the supplier vehicle.

7. The vehicle-to-vehicle charging service providing method of claim 3, wherein if the desired charging location input by the demander is the location of the supplier vehicle,
when sending the supplier information of the filtered suppliers to the demander in a selectable manner, the supplier information is provided to the demander in order of shortest to longest time from a current location of the demander vehicle to a destination via the location of the supplier vehicle.

8. The vehicle-to-vehicle charging service providing method of claim 3, wherein if the desired charging location input by the demander is the location of the supplier vehicle,
when sending the supplier information of the filtered suppliers to the demander in a selectable manner, the supplier information is provided to the demander in order of smallest to largest required energy from a current location of the demander vehicle to a destination via the location of the supplier vehicle.

9. The vehicle-to-vehicle charging service providing method of claim 3, wherein if the desired charging location input by the demander is the location of the supplier vehicle, the demander selects one of shortest distance, shortest time, and minimum energy options; and
when sending the supplier information of the filtered suppliers to the demander in a selectable manner, between a distance, time, and required energy from a current location of the demander vehicle to a destination via the location of the supplier vehicle, information corresponding to the option selected by the demander is provided to the demander in order of shortest to longest or smallest to largest.

10. A vehicle-to-vehicle charging service providing system for performing the vehicle-to-vehicle charging service providing method of claim 1, the system comprising:
the supplier terminal;
the demander terminal; and
the server.

11. A vehicle-to-vehicle charging service providing method, comprising:
receiving, by a server from a demander terminal of each of a plurality of demanders who want to charge an electric vehicle, demander information;
receiving, by the server from a supplier terminal of a supplier who wants to charge another electric vehicle, supplier information, which is charging related information that can be provided;
filtering demanders corresponding to the supplier information based on demander information of the server;
sending demander information of the filtered demanders to the supplier terminal of the supplier in a selectable manner;
receiving demander information of one of the filtered demanders selected by the supplier from the supplier terminal; and
transmitting, by the server, completion information indicating completion of charging reservation matching to the demander terminal of the demander selected by the supplier and to the supplier.

12. The vehicle-to-vehicle charging service providing method of claim 11, wherein the demander information received by the server includes information of at least one of a desired charging start time, a required charging capacity, a desired charging location, a location of a demander vehicle, a driving destination, and a demand price; and
the supplier information received from the supplier includes information of at least one of start and end times of available supply, an available charging capacity, a location of a supplier vehicle, and an available supply distance.

13. The vehicle-to-vehicle charging service providing method of claim 12, wherein the filtering the demanders corresponding to the supplier information comprises determining whether a demander:
has the required charging capacity smaller than the available charging capacity;
has the desired charging start time falling within the start and end times of available supply; and
has transmitted demander information in which a time, which ranges from an expected charging start time that is a later time between a time at which the demander vehicle is expected to be able to move to a charging location and a time at which the supplier vehicle is expected to be able to move to the charging location to a time that results from adding to the expected charging start time a charging preparation time and a time expected to be required to charge the required charging capacity, falls within the start and end times of available supply is selected as a demander corresponding to the supplier information.

14. The vehicle-to-vehicle charging service providing method of claim 12, wherein when sending the demander information of the filtered demanders to the supplier in a selectable manner,
only demander information of which the desired charging location input by the demander falls within the available supply distance is selected and provided.

15. The vehicle-to-vehicle charging service providing method of claim 14, wherein the available supply distance of the supplier is changeably set by the supplier, and the available supply distance set by the supplier is limited to a distance the supplier vehicle is able to reach on the basis of remaining electric energy at present.

16. A vehicle-to-vehicle charging service providing system for performing the vehicle-to-vehicle charging service providing method of claim 11, the system comprising:
the supplier terminal;
the demander terminal; and
the server.
